(19) United States
(12) Patent Application Publication
(10) Pub. No.: US 2016/0113234 A1
(43) Pub. Date: Apr. 28, 2016

(54) COILED PET URINE PAD AS WELL AS PRODUCTION METHOD AND PROCESSING EQUIPMENT THEREOF

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 14/924,588

(22) Filed: Oct. 27, 2015

(30) Foreign Application Priority Data
Oct. 27, 2014 (CN) 201410578054.6

(51) Int. Cl. A01K 1/015; B65H 19/22; B65H 18/10

(52) U.S. Cl. CPC A01K 1/0157; B65H 18/10; B65H 19/2207; B65H 2301/41461

(57) ABSTRACT

A coiled pet urine pad includes multiple single pet urine pads, wherein every two adjacent single pet urine pads are connected through a breakpoint line, and the multiple independent single urine pads are coiled in sequence from inside to outside to form a coiled integral body. A coiled pet urine pad processing equipment includes a pet urine pad processing main machine frame and a conveying device arranged on the pet urine pad processing main machine frame. A buffer device frame is arranged at the rear end of the pet urine pad processing main machine frame, and a buffer device is arranged on the buffer device frame. A coiling device frame is arranged at the rear end of the buffer device frame and a coiling device is arranged on the coiling device frame.

### CROSS-REFERENCE TO RELATED APPLICATIONS

This Application claims priority of Chinese Patent Application No. CN201410578054.6, filed on Oct. 27, 2014, the disclosure of which is incorporated by reference in its entirety.

### TECHNICAL FIELD

The invention relates to a coiled pet urine pad as well as a production method and processing equipment thereof

### BACKGROUND ART

With the development of society and growth in the living standard, people also continually pursue spiritual life while enjoying material life, so more and more people yearn for natural ease, and keeping pets has gradually become a kind of popular fashion. In daily life, pet urine pads are generally used by people to clear excrements of pets. However, existing single pet urine pads are connected by breaking-point lines, directly folded and then put into packaging bags for package and use, and thus are convenient to use and occupy a relatively large space since the storage function is not ideal in the use process, and therefore the aesthetic property of the household environment is affected. In order to solve such problems, technical staff of pet product manufacturing enterprises makes improvement on existing pet urine pad processing and production equipment.

### SUMMARY OF THE PRESENT INVENTION

The technical problem to be solved by the present invention is to provide a coiled pet urine pad.

In order to solve said technical problem, the technical solution adopted by the present invention is as follows: the coiled pet urine pad comprises multiple single pet urine pads, wherein every two single urine pads are connected by means of a breaking-point line, and the multiple independent single urine pads are coiled in sequence from inside to outside to form a coiled integral body.

The technical solution to be solved by the present invention is to provide a production method of the coiled pet urine pad.

In order to solve said technical problem, the technical solution adopted by the invention is as follows: the production method of the coiled pet urine pad comprises the following steps: conveying a single pet urine pad produced by a pet urine pad processing main machine to a buffer device through a conveying device, every two single pet urine pads are connected through a breaking-point line, and the buffered single pet urine pad enters a coiling device for coiling.

The technical solution to be solved by the present invention is to provide processing equipment of the coiled pet urine pad.

In order to solve said technical problem, the technical solution adopted by the present invention is that: the processing equipment of the coiled pet urine pad comprises a pet urine pad processing main machine frame and a conveying device arranged on the pet urine pad processing main machine frame, wherein a buffer device frame is arranged at the rear end of the pet urine pad processing main machine frame, a buffer device is arranged on the buffer device frame, a coiling device frame is arranged on the rear end of the buffer device frame and a coiling device is arranged on the coiling device frame.

In order to well solve said technical problem, the further technical solution to be adopted by the present invention is as follows: the structure of the coiling device comprises a main shaft arranged in the middle of the coiling device frame, wherein a driven pulley is arranged on one side of the main shaft and is connected with a driving pulley on a drive motor through a driving belt, the drive motor is fixedly arranged on the coiling device frame, and wallboards between which multiple cloth guide rollers are arranged are arranged on two sides of the main shaft, respectively; an upper coiling device and a lower coiling device which are identical in structure are arranged on the two wallboards, respectively, wherein the structure of the upper coiling device comprises baffle plates arranged on the inner sides of the two wallboards respectively and mounting bases arranged on the outer sides of the two wallboards respectively, wherein coiling shafts are movably arranged inside the baffle plates and the mounting bases, one ends of coiling shafts are connected with piston rods of telescopic cylinders through connecting rods, and the two telescopic cylinders are fixedly arranged on the outer sides of the two wallboards, respectively.

The present invention has the advantages that the coiled pet urine pad as well as the production method and processing equipment thereof are high in production efficiency; the produced coiled pet urine pad convenient to take is convenient and efficient to use, occupies a small space and is convenient to draw, transport and store since the multiple independent single urine pads are sequentially coiled from inside to outside to form a coiled integral body, and thus beautifies the household environment, keeps the household environment clean and tidy and alleviates the labor intensity of people.

### BRIEF DESCRIPTION OF THE DRAWINGS

FIG. 1 is a structural schematic diagram of the processing equipment of the coiled pet urine pad in the present invention.

FIG. 2 is a side-view structural schematic diagram of the coiling device in FIG. 1.

FIG. 3 is a structural schematic diagram of the coiled pet urine pad in the present invention.

FIG. 4 is a structural schematic diagram when the coiled pet urine pad is put in a urine pad packaging box in the present invention.

In Figs.: the pet urine pad processing main machine frame 1, the conveying device 2, the buffer device frame 3, the buffer device 4, the coiling device frame 5, the single pet urine pad 6, the breaking-point line 7, the main shaft 8, the driving pulley 9, the driving belt 10, the drive motor 11, the driving pulley 12, the wallboard 13, the cloth guide roller 14, the baffle plate 15, the mounting base 16, the coiling shaft 17, the connecting rod 18, the telescopic cylinder 19, the piston rod 20, the coiled pet urine pad 21, the urine pad packaging box 22, the upper cover 23 and the pulling opening 24 are described.

### DETAILED DESCRIPTIONS

The specific content of the present invention is described in detail below in conjunction with the accompanying drawings and specific embodiments

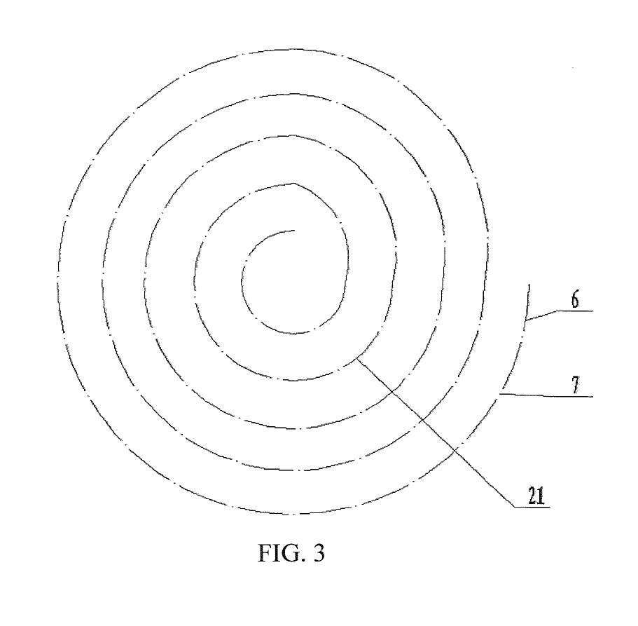

As can be seen from FIG. 3, the coiled pet urine pad comprises multiple single pet urine pads 6, wherein every two adjacent single pet urine pads 6 are connected through the breaking-point line 7, and the multiple independent urine pads 6 are sequentially coiled from inside to outside to form the coiled integral body.

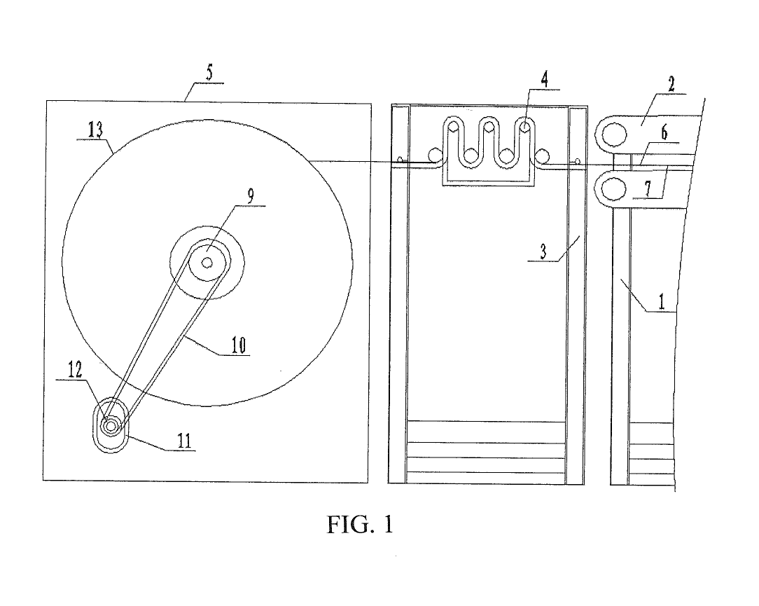

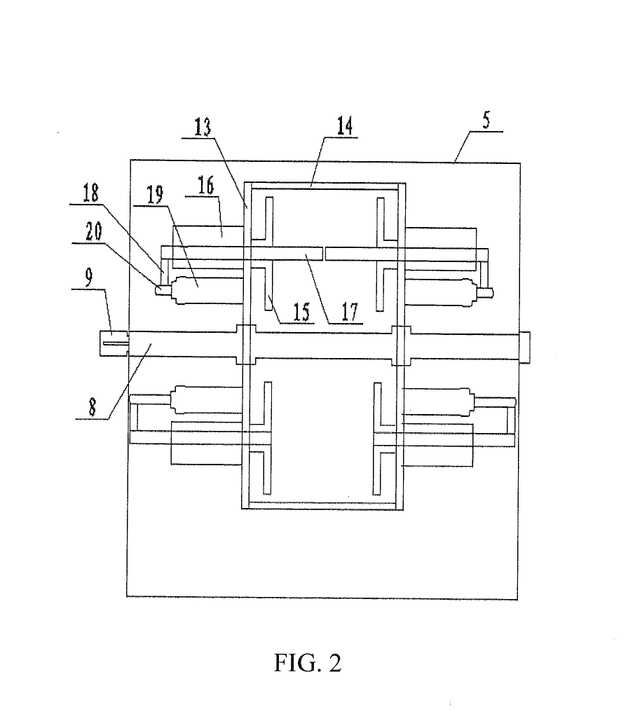

As can be seen from FIG. 1 and FIG. 2, the production method of the coiled pet urine pad comprises the following steps: conveying the single pet urine pad 6 produced by the pet urine pad processing main machine to the buffer device 4 through the conveying device 2, every two single pet urine pads 6 are connected through the breaking-point line 7, and the buffered single pet urine pad 6 enters the coiling device for coiling.

As can be seen from FIG. 1 and FIG. 2, the processing equipment of the coiled pet urine pad comprises the pet urine pad processing main machine frame 1 and the conveying device 2 arranged on the pet urine pad processing main machine frame 1, wherein the buffer device frame 3 is arranged on the rear end of the pet urine pad processing main machine frame 1, the buffer device 4 is arranged on the buffer device frame 3, the coiling device frame 5 is arranged at the rear end of the buffer device frame 3 and the coiling device is arranged on the coiling device frame 5.

As can be seen from FIG. 1 and FIG. 2, the structure of the coiling device comprises the main shaft 8 arranged in the middle of the coiling device frame 5, wherein the driven pulley 9 is arranged on one side of the main shaft 8 and is connected with the driving pulley 12 on the drive motor 11 through the driving belt 10, the drive motor 11 is fixedly arranged on the coiling device frame 5, and wallboards 13 between which multiple cloth guide rollers 14 are arranged are arranged on two sides of the main shaft 8, respectively; the upper coiling device and the lower coiling device which are identical in structure are arranged on the two wallboards 13, respectively, wherein the structure of the upper coiling device comprises baffle plates 14 arranged on the inner sides of the two wallboards 13 respectively and mounting bases 16 arranged on the outer sides of the two wallboards 13 respectively, wherein coiling shafts 17 are movably arranged inside the baffle plates 15 and the mounting bases 16, one ends of coiling shafts 17 are connected with piston rods 20 of telescopic cylinders 19 through connecting rods 18, and the two telescopic cylinders 19 are fixedly arranged on the outer sides of the two wallboards 13 respectively.

As can be seen from FIG. 2, the working principle of the coiling device lies in that: the drive motor 11 drives the driving pulley 12 and the main shaft 8 to rotate through the driving belt 10, the main shaft 8 drives the wallboards 13 and the cloth guide rollers 14 to rotate, the single pet urine pad 6 enters the cloth guide rollers 14 and rotates, the telescopic cylinders 19 work to drive the piston rods 20 to stretch out and draw back, and the piston rods 20 drive the coiling shafts 17 to stretch out and draw back through the connecting rods 18; as can be seen from FIG. 2, the two coiling shafts 17 stretch out synchronously, the upper coiling device is at a coiling state, the telescopic cylinders 19 drive the piston rods 20 to draw back after the coiling is ended, the piston rods 20 drive the coiling shafts 17 to draw back through the connecting rods 18, and the coiled pet urine pad 21 as shown in FIG. 3 is taken down by manpower. Then, the two coiling shafts 17 on the lower coiling device stretch out synchronously, and the lower coiling device is at a coiling state. Again and again, thus continuous coiling is realized.

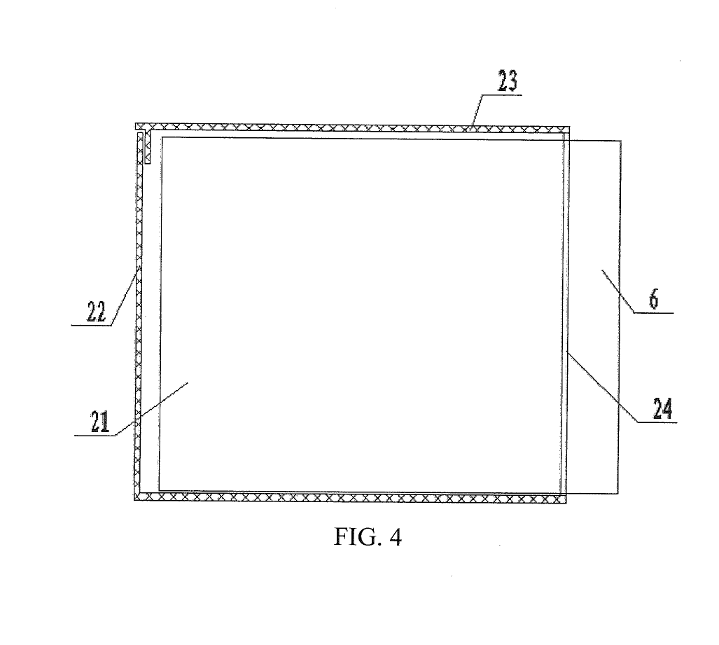

As can be seen from FIG. 3 and FIG. 4, the coiled pet urine pad 21 is put in the urine pad packaging box 22, the upper cover 23 is arranged at the upper end of the urine pad packaging box 22, and the pulling opening 24 from which the single pet urine pad 6 is pulled out is formed in one side of the urine pad packaging box 22.

What is claimed is:

1. A coiled pet urine pad, comprising multiple single pet urine pads (6), wherein every two adjacent single pet urine pads (6) are connected through a breakpoint line (7), and the multiple independent single urine pads (6) are coiled in sequence from inside to outside to form a coiled integral body.

2. A production method of the coiled pet urine pad according to claim 1, comprising the following steps: conveying the single pet urine pad (6) produced by a pet urine pad processing main machine to a buffer device (4) through a conveying device (2), and feeding the buffered single pet urine pad (6) to a coiling device for coiling, wherein every two single pet urine pads (6) are connected through a breaking-point line (7).

3. A processing equipment of the coiled pet urine pad according to claim 1, comprising a pet urine pad processing main machine frame (1) and a conveying device (2) arranged on the pet urine pad processing main machine frame (1) and also characterized in that a buffer device frame (3) is arranged at the rear end of the pet urine pad processing main machine frame (1), a buffer device (4) is arranged on the buffer device frame (3), a coiling device frame (5) is arranged on the rear end of the buffer device frame (3) and a coiling device is arranged on the coiling device frame (5).

4. The processing equipment of the coiled pet urine pad according to claim 3, wherein the structure of the coiling device comprises a main shaft (8) arranged in the middle of the coiling device frame (5), wherein a driven pulley (9) is arranged on one side of the main shaft (8) and is connected with a driving pulley (12) on a drive motor (11) through a driving belt (10), the drive motor (11) is fixedly arranged on the coiling device frame (5), and wallboards (13) between which multiple cloth guide rollers (14) are arranged are arranged on two sides of the main shaft (8), respectively; an upper coiling device and a lower coiling device which are identical in structure are arranged on the two wallboards (13), respectively, wherein the structure of the upper coiling device comprises baffle plates (14) arranged on the inner sides of the two wallboards (13) respectively and mounting bases (16) arranged on the outer sides of the two wallboards (13) respectively, wherein coiling shafts (17) are movably arranged inside the baffle plates (15) and the mounting bases (16), one ends of coiling shafts (17) are connected with piston rods (20) of telescopic cylinders (19) through connecting rods (18), and the two telescopic cylinders (19) are fixedly arranged on the outer sides of the two wallboards (13) respectively.
